(19) United States
(12) Patent Application Publication
(10) Pub. No.: US 2007/0276912 A1
(43) Pub. Date: Nov. 29, 2007

(54) Apparatus and method for forming and communicating a responsive data message

(76) Inventor: Mike Rybak, Kitchener (CA)

Correspondence Address: DOCKET CLERK, PO BOX 12608, DALLAS, TX, 75225, US

(21) Appl. No.: 11/418,814

(22) Filed: May 5, 2006

(51) Int. Cl. G06F 15/16

(52) U.S. Cl. 709/206

(57) ABSTRACT

Apparatus, and associated method, for facilitating communication of a data message, such as an e-mail message, in a bandwidth constrained communication system. An incoming data message is delivered to a mobile station. A responsive data message is formed by inserting responsive text into the incoming data message. A determiner determines differences between the incoming and responsive data messages, and a coder forms a coded message that identifies the determined differences. The coded message, rather than the entire responsive data message is communicated by the mobile station as a response to the incoming data message.

The present invention relates generally to the communication of data messages, such as e-mail messages, in a radio, or other, communication system. More particularly, the present invention relates to apparatus, and an associated method, by which to permit a response message, generated responsive to an incoming data message and formed of responsive text imbedded in the incoming data message, to be communicated in a spectrally-efficient, encoded form and later recreated.

### BACKGROUND OF THE INVENTION

While once a novelty, communication by way of e-mail, or other data, messaging has become a regular, if not pervasive, manner by which to exchange information for many. E-mail and other store and forward communication techniques and schemes permit parties to the communications to communicate asynchronously. That is to say, a sender that sends a message does not require the recipient simultaneously to be positioned and available to receive the sent message. Instead, the message remains available for subsequent viewing and response by the recipient. If the recipient of the message is occupied or unavailable when the message is delivered, or otherwise made available for review, the recipient need not immediately review the message but, instead, can later review and respond, according to the recipient's convenience.

Historically e-mail, and other data, messages were communicated between local-network-connected computer stations. Later, with the advent of the internet, communication of messages between computer stations positioned at virtually any location and interconnected by way of the internet became possible. And, advancements in radio communication technologies have permitted e-mail, and other data, messaging to be performed using mobile communication stations connected to a network by way of a radio air interface.

Communications in a radio environment differ in various aspects with communications carried out by way of wire line networks. Amongst the differences is the relatively greater need to communicate in a spectrally-efficient manner due to bandwidth constraints that are typically imposed in a radio communication system. In spite of the special constraints imposed upon communications in a radio communication system, efforts are made also to provide for the messaging services in manners that, from the perspective of the user, are transparent. That is to say, e-mail, and other data, messaging operations are generally preferred to be similar from the perspective of the users, irrespective of the communication mechanism, i.e., wireline or radio, by way of which the messages are communicated.

Sometimes, when a recipient responds to a delivered e-mail, the recipient inserts responsive text into the body of the delivered message. For instance, if the delivered message includes a series of questions, the recipient might desire to respond to the questions by inserting responsive text immediately following each of the questions using a text editor. That is to say, the responsive text is inserted, or embedded, in the delivered message. And, the resultant, responsive message is formed of both the delivered message and the responsive text inserted therein. If the message includes an attachment, the recipient might want to make a change to the attachment or add, or substitute, an attachment.

Transmission of the responsive message back to the sending station includes redundant information. That is to say, the responsive message includes not only the newly-entered, responsive text but also the text of the original message and, if any, its attachment. The communication of the redundant information is bandwidth consumptive. Most simply, a user can be prohibited from inserting the responsive text into the delivered message. However, this prohibition is sometimes seen as a drawback as the recipient is unable to respond to the delivered message in the manner that the recipient prefers. And, in any event, the prohibition reduces the communication transparency. The prohibition generally does not occur in messaging effectuated by way of a wireline communication system, only in a radio communication system.

An improved manner by which to provide for, and communicate, a responsive data message is therefore required.

It is in light of this background information related to the communication of data messages in a communication system that the significant improvements of the present invention have evolved.

### BRIEF DESCRIPTION OF THE DRAWINGS

FIG. 1 illustrates a functional block diagram of a radio communication system in which an embodiment of the present invention is operable.

FIG. 2 illustrates exemplary messages formed during operation of the communication system shown in FIG. 1.

FIG. 3 illustrates a partial message sequence, partial flow, diagram representative of exemplary operation of an embodiment of the present invention.

FIG. 4 illustrates a method flow diagram illustrating the method of operation of an embodiment of the present invention.

### DETAILED DESCRIPTION

The present invention, accordingly, advantageously provides apparatus, and an associated method, for facilitating communication of data messages, such as e-mail messages, in a radio, or other, communication system.

Through operation of an embodiment of the present invention, a manner is provided by which to permit a response message, generated responsive to an incoming message and formed of responsive text embedded in the incoming data, to be communicated in a spectrally efficient manner and later recreated.

When, e.g., an e-mail recipient forms a response e-mail that is an edited version of the received e-mail, a coded message is formed, and the coded message is sent. Subsequent to delivery of the coded message, the response e-mail is recreated using the coded message.

In one aspect of the present invention, a data message, such as that forming an e-mail message comprised of a sequence of alphanumeric characters, is formed by a message originator, such as through text entry at a computer, or other communication, station. The message, once generated, is sent, by way of a radio channel defined on a radio air interface, to a receiving station, such as a mobile station. Communications are effectuated, for instance, pursuant to the operating protocols set forth in the operating specification of a cellular communication system standard that provides for data communications, such as a GSM/GPRS (Global System for Mobile communications/General Packet Radio Service) or CDMA/1xEV-DO (Code Division Multiple Access/data only) communication scheme. The data message, when received at the receiving station, is operated upon in conventional manner to permit its display upon a user display element of a receiving station. In conventional manner, the message is either pushed to the receiving station or is stored at a store and forward location, available for retrieval by the retrieving station, such retrieval, i.e., pulling of the message, constituting the communication of the message upon the radio air interface.

The incoming data message is also stored at the receiving station. The recipient of the message is able, also in conventional manner, to create a responsive message in response to the incoming message. The responsive message is formed pursuant to a reply or forward, by the user, of the incoming message. The responsive message is formed, for instance, through operation of a text editor embodied at the receiving station. That is to say, the incoming data message is edited to form the responsive message. The incoming data message might also include an attachment. And, the recipient might also want to make alteration to the message as part of the response. That is to say, the incoming data message might include an attachment and the attachment forms part of the incoming data message. And, the responsive message includes changes to the attachment. When the responsive message is formed, its contents are compared with the contents of the incoming data message, that is, the earlier-sent message whose contents are stored at the receiving station and responsive to which the responsive message is formed. The comparison determines differences between the incoming data message and the responsive data message. The differences identify additions to, deletions from, and modifications to the incoming data message. When, for instance, the responsive message is formed of responsive text inserted into the incoming data message, the differences constitute the responsive text inserted into the incoming data message. The differences are determined, for instance, by operation of a UNIX Diff operation or by performance of a Delta operator.

To determine the differences, determinations are made of the locations of the incoming data message at which the responsive text is inserted. These locations are identified, for instance, by a byte offset or by identifying incoming data message text immediately preceding or following the responsive text.

An encoder forms a coded message responsive to the determinations of the differences between the incoming and responsive data messages and the locations at which the respective messages differ. The encoded message includes all of the information required to recreate the responsive data message when the contents of the incoming data message are known. When the response to the incoming data message is to be provided to, or routed by way of, a node at which the contents of the incoming data message are stored, the responsive data message is recreatable without the need for communicating the entire responsive data message; instead, only the coded message is sent. When the receiving communication station and the remote node are interconnected by way of a radio air interface, the bandwidth requirements required to communicate the coded message are less, typically, than the bandwidth requirements needed to communicate the entire responsive data message. Spectrally efficient communication of the recipient's reply to an incoming data message is thereby provided.

In a further aspect of the present invention, a node is adapted to receive a coded message that includes an indication of differences between the incoming and responsive data messages together with the locations of the incoming data message at which the changes occur. The node is also provided with the contents of the incoming data message, such as access to a storage element at which the contents of the incoming data message are buffered. A data message recreator recreates the responsive data message by making use of the coded message and the retrieved contents of the incoming data message. Once recreated, the recreated, responsive data message is forwarded on to its destination.

Thereby, through operation of an embodiment of the present invention, the responsive data message prepared in response to an incoming data message is communicated in a spectrally efficient manner. When communicated in a bandwidth constrained system, such as a radio communication system, the reduced bandwidth requirements needed to communicate the informational content of the responsive data message permits the more efficient utilization of the allocated communication resources.

In these and other aspects, therefore, apparatus, and an associated method, are provided for a communication station operable pursuant to a data communication session. An incoming data message is deliverable to the communication station, and a responsive data message is formable to respond to the incoming data message. A determiner is adapted to receive indications of the incoming data message and of the responsive data message. The determiner is configured to determine differences between the incoming data message and the responsive data message. A coder is adapted to receive an indication of the differences determined by the determiner. The coder is configured to form a coded message that identifies differences between the incoming and responsive data messages, respectively, and each location within the incoming data message at which the responsive data message differs with the incoming data message. The coded message is for communication by the communication station.

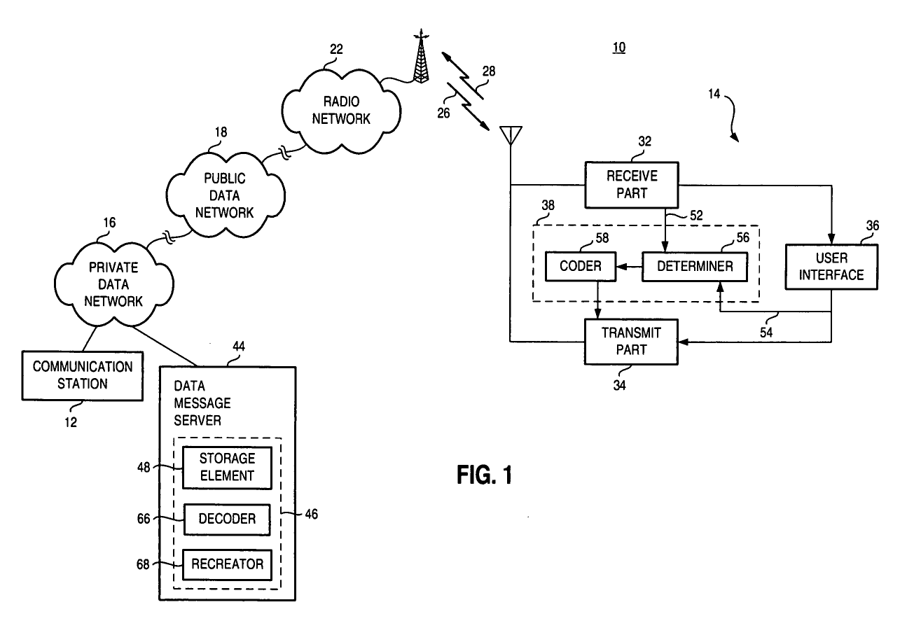

Referring first, therefore, to FIG. 1, a communication system, shown generally at 10, provides for the communication of data messages, such as e-mail messages. In the exemplary implementation, the communication system 10 includes a network part and a radio part. The radio part, in the exemplary implementation, forms a cellular communication system operable pursuant to the protocols of a selected, operating specification. While the following description shall describe exemplary operation in which the radio part of the communication system forms a cellular communication network, in other implementations, the communication system is constructed in other manners. Operation of an embodiment of the present invention is analogously implementable in any of various other communication systems and communication schemes.

Additionally, description of operation shall be described with respect to a data message originated at a communication station 12, delivered to a mobile communication station 14 and a responsive data message returned by the mobile station 14 to the communication station 12. Communication of data messages originated, or terminated, at other communication stations, or in the reverse direction, i.e., originated at the mobile station 14, are analogous, and description of operation of the communication station can analogously be made with respect to such other communication operations.

The network part of the communication system is here formed of three portions, a private data network 16, a public data network 18, and a radio network 22. The networks 16, 18 and 22 are operable generally in conventional manner to route data messages therethrough. The private data network 16 is representative, e.g., of an enterprise LAN (Local Area Network) to which the communication station 12 is connected and forms a portion.

The public data network comprises, e.g., the Internet, or other public-access data network to which the private data network is connectable in communication connectivity. The public data network, in turn, is connected, in communication connectivity with the radio network 22. As noted above, the radio network forms the network portion of a cellular communication network, operable in conformity with the operating protocols of a cellular communication system, such as a GSM/GPRS (Global System for Mobile communications/General Packet Radio Service) or CDMA/1xEV-DO (Code Division Multiple Access/data only) operating specification.

A radio air interface is defined between the radio network 22 and the radio air interface is defined in the operating specification pursuant to which the radio network 22 and the mobile station 14 are operable. Downlink and uplink channels, represented by the arrows 26 and 28, are defined upon the radio interface, thereby to position the mobile station in communication connectivity with the network part of the communication system.

The mobile station includes transceiver circuitry, here represented by a receive part 32 and a transmit part 34 selectably operable to transceive data messages, such as e-mail messages, formed of alphanumeric text or characters. Data messages communicated to the mobile station are received at, and operated upon, by the receive part 32. And, data messages, such as a responsive data message formed in response to the reception of an incoming data message, are communicated by the transmit part 34. In the exemplary implementation in which the mobile station also provides for voice communications, the receive and transmit parts 32 and 34 also operate to receive and transmit traffic, i.e., voice, data. The mobile station 14 further includes a user interface 36 coupled to the receive and transmit parts 32 and 34. The user interface operates as a user interface, both to display received data messages, such as on a screen display, and to receive user inputs, such as text-entered symbols entered by a user by way of a keypad, or the like.

The mobile station 14 further includes apparatus 38 of an embodiment of the present invention. The apparatus 38 is functionally represented, formed of functional elements, implementable in any desired manner, including algorithms executable by processing circuitry.

In operation, the apparatus operates to facilitate a response to an incoming data message, herein e-mail originated at the communication station 12 sent to the mobile station by way of the network part of the communication system and the radio air interface. The response to the incoming message is made when the user of the mobile station elects to reply to or to forward, with comment, the incoming message. In the exemplary implementation, the data message is routed by way of a data message server 44 that is connected to the network part, here the private data network 16, of the communication system. The data message server performs various operations, and also includes apparatus 46 of an embodiment of the present invention. The apparatus also is functionally presented, formed of functional elements, implementable in message that is received at the mobile station, subsequent to routing through the network part and transmission upon a downlink channel of the radio air interface.

The apparatus 38 embodied at the mobile station is coupled to the receive part 32 and is provided with indications, here indicated by way of the line 52, of the contents of the incoming data message. The line 52 extends to a determiner 56. The determiner is also provided, here indicated by way of the line 54, with indications of a responsive data message that is formed in response to the incoming data message, for return to the communication station or for routing elsewhere to another communication station. The responsive data message, e.g., is formed of the text of the incoming data message together with responsive message text inserted into the body of the incoming data message text. For instance, if the incoming data message is formed of a series of questions, the recipient of the incoming data message at the mobile station might elect to respond to the message by inserting answers to the questions immediately following the questions. That is to say, the responsive data message is formed of the answers to the questions inserted immediately following the questions of the incoming e-mail message. The responsive data message, therefore, differs with the incoming data message by the responsive text that is inserted into the incoming data message. Deletions of portions of the text of the incoming data message analogously also are differences between the incoming data message and the responsive data message.

The determiner 56 operates to determine the differences between the content of the incoming data message and the content of the responsive data message that is formed by the user when replying or forwarding the incoming message. The differences are determined by a delta operator or through performance of a comparison operation or tool. The comparison operation or tool operates in a manner akin to a Unix tool, a DIFF command. That is to say, the comparison operation or tool that computes and encodes the differences. In other implementations, differences are determined in other manners. The determiner also operates to determine the locations within the incoming data message that the responsive text is entered. Determinations made by the determiner are provided to a coder 58. The coder 58 operates to generate a coded message that includes the determinations made by the determiner. That is to say, the coded message includes the responsive text of the responsive data message and values representative of the locations of the incoming data message at which the responsive text is inserted. The coded message, once formed, is provided to the transmit part 34 for representative of the locations of the incoming data message at which the responsive text is inserted. The coded message, once formed, is provided to the transmit part 34 for communication back to the network part by way of the radio air interface. The coded message, rather than the entire responsive data message is communicated, thereby providing information permitting the responsive data message to be recreated, but without requiring the communication of the redundant information upon the radio air interface.

The coded message, once delivered to the network part is routed therethrough and delivered to the data message server 44 at which the apparatus 46 is embodied.

The apparatus 46 further includes a decoder 66 that operates to decode the coded message and a data message recreator 68 that operates, responsive to the decoded message, and to access to the buffered data message stored at the storage element 48, to recreate the responsive data message. With knowledge of the contents of the incoming data message and of the coded message, the responsive data message is readily recreatable, available for delivery to a recipient station, such as the communication station 12. Thereby, the responsive data message, in the form intended by the user of the mobile station 12 is provided to an intended recipient station without necessitating the entire message to be communicated by way of the radio air interface. That is to say, the data message server recreates the reply message using the coded message and the email message and then routes the recreated message on to a recipient.

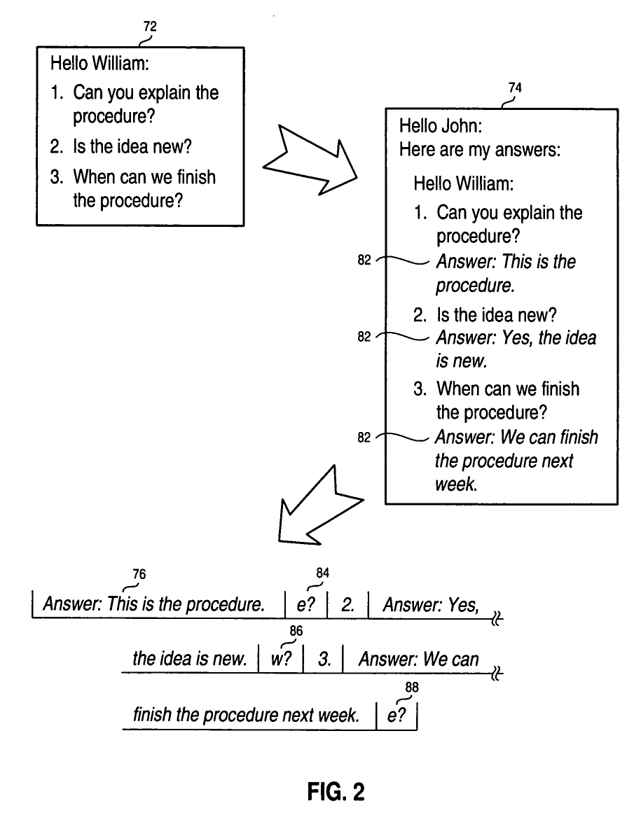

FIG. 2 illustrates an exemplary incoming data message 72 and exemplary responsive data message 74, and an exemplary coded message 76.

As the example shown in FIG. 2 illustrates, the incoming data message is formed of text data, and the responsive data message is formed of both the incoming text data as well as, additionally, responsive text data 82. And, the coded message 76 includes the responsive text data 82 and an indication of the location within the incoming data message at which the responsive text is located. The example shown in the Figure identifies portions 84, 86 and 88, text segments of the incoming data segment proximate to the corresponding responsive text message. In one implementation, byte offsets are used in substitution for the segments 84, 86 and 88.

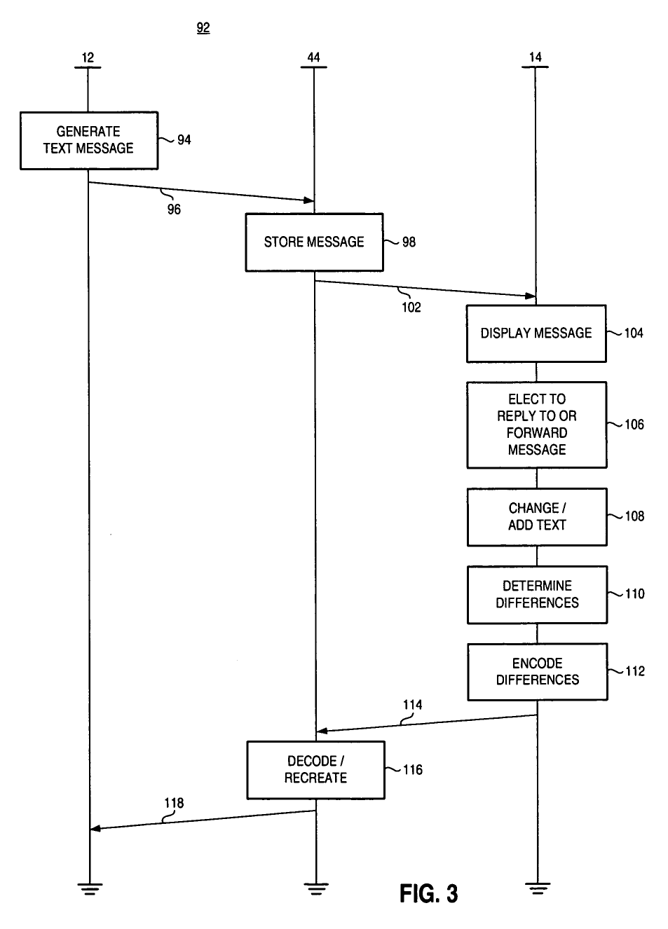

FIG. 3 illustrates a message sequence diagram, shown generally at 92, representative of exemplary operation of an embodiment of the present invention in which a user of a mobile station replies to (or forwards) a received message. The diagram also illustrates the communication station 12 shown in FIG. 1, and sent to a mobile station, such as the mobile station 14.

First, and as indicated by the block 94, a text message is generated. Then, as indicated by the segment 96, the generated text message is communicated by the communication station. The message is routed to the data message server 44 and, as indicated by the block 98, the contents of the message are stored at the server. The message then is routed, indicated by the segment 102, on to the mobile station.

At the mobile station, the text message is displayed, indicated by the block 104. Then, and as indicated by the block 106, a user of the mobile station elects to reply to, or forward, the received message. And, then, as indicated by the block 108, a user of the mobile station adds to, or changes, the text of the incoming data message, thereby to alter the message. Then, and as indicated by the block 110, determinations of the differences between the incoming message and the responsive message are determined by comparing the incoming and responsive messages. The comparison is, e.g., akin to a Unix diff operation. And, as indicated by the block 112, the differences are encoded to form a coded message. The coded message also indicates where in the incoming data message that the responsive text is inserted.

Then, and as indicated by the segment 114, the coded message is sent to a recipient station, here the communication station 12, and by way of the server 44. When delivered to the server 44, the coded message is decoded and a recreated responsive data message is formed that corresponds to the responsive data message formed at the mobile station. That is to say, the data message server recreates the responsive, i.e., reply, message, using the coded message and the stored message. And, once formed, the recreated message is sent, indicated by the segment 118, on to the recipient station.

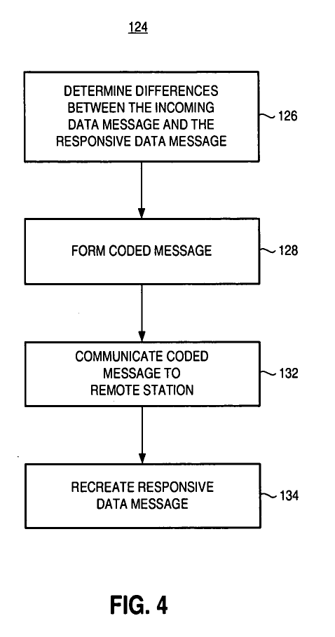

FIG. 4 illustrates a method flow diagram, shown generally at 124, representative of the method of operation of an embodiment of the present invention. The method is for communicating at a communication station operable pursuant to a data communication session in which an incoming data message is deliverable to the communication station and a responsive data message is formable to respond to the incoming data message.

First, and as indicated by the block 126, differences are determined between the incoming data message and the responsive data message. Then, and as indicated by the block 128, a coded message is formed.

Then, and as indicated by the block 132, the coded message is communicated to a remote station. Then, and as indicated by the block 134, the responsive data message is recreated.

When delivered to a destination station, the recreated responsive data message is available for viewing. But, because the coded message, rather than the entire responsive data message, is sent, improved spectral efficiency of communications is provided. The previous descriptions are of preferred examples for implementing the invention, and the scope of the invention should not necessarily be limited by this description. The scope of the present invention is defined by the following claims.

What is claimed:

1. Apparatus for a communication station operable pursuant to a data communication session in which an incoming data message is deliverable to the communication station and a response data message formable to respond to the incoming data message, said apparatus comprising:
a determiner adapted to receive indications of the incoming data message and of the responsive data message, said determiner configured to determine differences between the incoming data message and the responsive data message;
a coder adapted to receive an indication of the differences determined by said determiner, said coder configured to form a coded message identifying the differences between the incoming and responsive data messages, respectively, and each location within the incoming data message at which the responsive data message differs with the incoming data message, the coded message for communication by the communication station.

2. The apparatus of claim 1 wherein the incoming data message compares an incoming alphanumeric text message, wherein the responsive data message compares a responsive alphanumeric text message, and wherein said determiner is configured to determine each differing alphanumeric character that differs between the incoming and responsive alphanumeric text messages, respectively.

3. The apparatus of claim 1 wherein the incoming alphanumeric text message comprises an incoming e-mail message, wherein the responsive alphanumeric text message comprises a responsive e-mail message, the responsive e-mail message selectably including, as a part thereof, at least a portion of the incoming e-mail message, and wherein the differences determined by said determiner identify responsive alphanumeric text of the responsive email message.

4. The apparatus of claim 3 wherein the responsive alphanumeric text of the responsive e-mail message is inserted into the incoming e-mail message and wherein said determiner further identifies the location within the incoming e-mail at which the responsive alphanumeric text is positioned.

5. The apparatus of claim 3 wherein the coded message formed by said coder includes the responsive alphanumeric text identified by said determiner.

6. The apparatus of claim 3 wherein the location within the incoming e-mail message, at which said determiner identifies the responsive alphanumeric text, is identified by an offset indication.

7. The apparatus of claim 3 wherein the location at which said identifier identifies the responsive alphanumeric text within the incoming e-mail message is identified using incoming alphanumeric text positioned before the responsive alphanumeric text.

8. The apparatus of claim 3 wherein the location at which said identifier identifies the responsive alphanumeric text within the incoming e-mail message is identified using incoming alphanumeric text positioned after the responsive alphanumeric text.

9. The apparatus of claim 1 wherein said determiner further is configured to identify each location within the incoming data message at which the responsive data message differs with the incoming data message and wherein said coder is further adapted to receive an indication of each location identified by said determiner.

10. The apparatus of claim 1 wherein said determiner determines the differences by performing a logical “diff” operation upon the incoming and responsive data messages, respectively.

11. The apparatus of claim 1 wherein said determiner comprises a Unix™ capable processing device permitting performance of a Unix™ tool, performance of the Unix™ tool determining the differences between the incoming data message and the responsive data message.

12. The apparatus of claim 11 wherein the Unix™ tool comprises a diff operation.

13. The apparatus of claim 1 wherein said determiner comprises a change operator configured to detect changes between the incoming and responsive data messages, respectively.

14. Apparatus for a communication station operable to receive a coded data message responsive to an earlier-sent incoming data message, said apparatus comprising:
a decoder adapted to receive the coded message, said decoder configured to decode the coded message into decoded from, the decoder from having responsive data message text and a location identifier that identifies a location indicia associated with the responsive data message text;
a responsive data message recreator adapted to receive the responsive data message text and the location identifier, said responsive data message recreator configured to recreate a responsive data message formed of at least portions of the incoming data message and the responsive data message text.

15. The apparatus of claim 14 father comprising a storage element accessible by said responsive data message recreator, said storage element configured to store values representative of the earlier sent incoming data message.

16. A method for communicating at a communication station operable pursuant to a data communication session in which an incoming data message is deliverable to the communication station and a responsive data message is formable to respond to the incoming data message, said method comprising the operations of:
determining differences between the incoming data message and the responsive data message;
forming a coded message, responsive to the differences determined during said operation of determining, the coded message identifying the differences between the incoming and responsive data messages, respectively and each location within the incoming data message at which the responsive data message differs with the incoming data message, the coded message for communication by the communication station.

17. The method of claim 16 further comprising the operation of communicating the coded message formed during said operation of coding to a remote station.

18. The method of claim 17 further comprising the operation of recreating in the responsive data message at the remote station using the coded message, once delivered to the remote station, an values of the incoming data message, earlier transmitted to the communication station.

19. The method of claim 18 further comprising the operation of forwarding the responsive data message, recreated during said operation of recreating, to an end-point station.

20. The method of claim 19 further comprising the operations, prior to said operation of determining, of;
originating the incoming data message at the end-point station;
communicating the incoming data message, by way of the remote station, to the communication station; and
storing values of the incoming data message at the remote station when the incoming data message is communicated to the communication station.
